(19) United States
(12) Patent Application Publication
(10) Pub. No.: US 2007/0193266 A1
(43) Pub. Date: Aug. 23, 2007

(54) MULTI-CYLINDER FREE PISTON STIRLING ENGINE

(75) Inventor: Robert F. McConaghy, Kirkland, WA (US)

Correspondence Address: KNOBBE MARTENS OLSON & BEAR LLP, 2040 MAIN STREET, FOURTEENTH FLOOR, IRVINE, CA, 92614, US

(73) Assignee: Stirling Cycles, Inc., Pasadena, CA (US)

(21) Appl. No.: 11/676,503

(22) Filed: Feb. 19, 2007

Related U.S. Application Data
(60) Provisional application No. 60/774,704, filed on Feb. 17, 2006.

(51) Int. Cl. F02G 1/04; F01B 29/10

(52) U.S. Cl. 60/520

(57) ABSTRACT

A Stirling engine machine comprises a plurality of opposing pairs of cylinder modules. Each cylinder module comprises a first end, a second end, and a piston moveable along a longitudinal axis extending between the first and second ends. The opposing pairs of cylinder modules have axes that are substantially aligned with each other such that movement of the pistons of opposing pairs substantially dynamically cancel. The opposing pairs of cylinder modules have first ends that are in proximity to each other.

### CLAIM OF PRIORITY

This application claims priority under 35 U.S.C. § 119(e) to U.S. Provisional Application No. 60/774,704, filed Feb. 17, 2006, the entirety of which is hereby incorporated by reference herein.

### BACKGROUND OF THE INVENTION

1. Field of the Invention

The present invention relates to engines and, more specifically, to Stirling engines.

2. Description of the Related Art

Conventionally, Stirling engines have two basic mechanical arrangements: kinematic and free-piston (non-kinematic) machines. Kinematic machines have mechanical linkages that define stroke and phase relationship between power pistons and/or displacer pistons through the use of connection rods, crankshafts, and the like. For example, one type of kinematic Stirling engines include a cylinder module that comprises an enclosed chamber, a displacer piston, a power piston and a crankshaft. The displacer piston is positioned within the enclosed chamber and is connected to the crankshaft by a displacer rod, which extends through the walls of the chamber. The power piston is also connected to the crankshaft through a piston rod and has one end that is in communication with the interior of the chamber. With respect to the crankshaft, the motion of the displacer piston leads the motion of the power piston by typically 90 degrees. In operation, the displacer piston moves working fluid from a cold side of the chamber to a hot side of the chamber. This causes the working fluid to expand. This expansion pushes the power piston and the piston rod, thereby rotating the crankshaft. As the crankshaft rotates, the displacer piston moves the working fluid to the cold side of the chamber. This causes the working fluid to contract, pulling the piston back into the working space. As the piston moves, the crankshaft rotates and the displacer piston moves the working fluid to the hot side of the chamber, thereby completing the cycle.

Certain kinematic Stirling engines have multiple cylinder modules that can be kinematically connected. An example of such an engine, is a kinematically connected, four cylinder engine that is commonly called the Rinia arrangement, after its Dutch inventor. In such an arrangement, a plurality of cylinder modules are interconnected by heater, a regenerator and a cooler in series. By connecting the ends of the modules with heaters regenerators and coolers, the pistons can operate in different phases of the Stirling cycle and alternately act as the displacer piston and the power piston relative to other cylinder modules in the engine.

Free piston engines typically include a cylinder module that comprises a displacer piston and a power piston that move independently from one another. Instead of mechanical linkages, relationships between the power and displacer pistons are determined by associated pressure wave interactions and resonant/spring/mass/damper characteristics. Free piston machines are generally mechanically simpler than kinematic machines but are typically more difficult to operate. Accordingly, free piston machines were traditionally limited to single cylinder module configurations. However, there have been recent efforts to develop a multi-cylinder free piston Stirling engine. See e.g., U.S. Pat. No. 7,134,279, the entire contents of which are hereby incorporated by reference herein.

In multi-cylinder Stirling engines (kinematic or free piston), it may be advantageous to use three cylinder modules, which are grouped together to form an engine that is capable of generating three phase AC power. When such engines are constructed, however, problems arise related to the inertial forces produced by active Stirling engine cylinder modules. Consequently, the engines can exert reaction forces on any supporting apparatuses, including a harmonic resonance that can degrade the support apparatus.

Accordingly, there exists a need to develop a system for arranging multiple cylinder modules of a Stirling engine to produce power without or with only minimal harmful inertial effects.

### SUMMARY OF THE INVENTION

Accordingly, one embodiment of the present invention comprises a Stirling engine machine that includes a plurality of opposing pairs of cylinder modules. Each cylinder module comprises a first end, a second end, and a piston moveable along a longitudinal axis extending between the first and second ends. The opposing pairs of cylinder modules have axes that are substantially aligned with each other such that movement of the pistons of opposing pairs substantially dynamically cancel each other. The opposing pairs of cylinder modules have first ends that are in proximity to each other.

Another embodiment of the present invention comprises a Stirling engine machine that includes a first group of cylinder modules. In the first group, each module comprises a piston that moves along a longitudinal axis. The machine also includes a second group of cylinder modules. Each of member of the second group of cylinder modules also comprises a piston that moves along a longitudinal axis. Each member of the second group of the cylinder modules corresponds to a member of the second group of cylinder modules such that the longitudinal axis of the corresponding member of the first group of cylinder modules is substantially aligned with the longitudinal axis of the corresponding member of the second group of cylinder modules. Stated differently, the Stirling cycle machine preferably comprises one or more pairs of cylinder modules, each pair of cylinder modules including a module from the first group and a module from the second group arrayed along a common longitudinal axis in opposite directions. The longitudinal axis associated with each pair of cylinder modules may lie in a common plane or in different planes.

Another embodiment of the present invention comprises a Stirling engine machine that has a first group of at least three cylinder modules and a second group of at least three cylinder modules. Each cylinder module comprises at least one piston that moves along a longitudinal axis. The longitudinal axes of the cylinder modules are substantially uniformly distributed in a radial pattern in a common plane with their longitudinal axes also oriented in a radial pattern.

Another embodiment of the present invention is Stirling engine machine that includes a first group of cylinder modules. Each cylinder module of the first group is characterized by a longitudinal axis. The longitudinal axes of the first group of cylinder modules are substantially parallel to each other and uniformly distributed in a first radial pattern in a first plane. The machine also includes a second group of cylinder modules. Each cylinder module of the second group is characterized by a longitudinal axis. The longitudinal axes of the second group of cylinder modules are substantially parallel to each other as well as the longitudinal axes of the first group, and uniformly distributed in a second radial pattern in a second plane.

### BRIEF DESCRIPTION OF THE DRAWINGS

FIG. 1 is a side perspective view of an embodiment of a Stirling engine machine.

FIG. 2 is a partial cross-sectional view of the Stirling engine machine of FIG. 1.

FIG. 3 is a schematic cross-sectional side view of the Stirling engine machine of FIGS. 1 and 2 with cylinder modules arranged in line to ease illustration of the inside of the Stirling engine.

FIG. 4 is a cross-sectional top view of another embodiment of a Stirling engine machine.

FIG. 5 is a wiring diagram of the embodiment of a Stirling engine machine shown in FIG. 4.

### DETAILED DESCRIPTION OF THE PREFERRED EMBODIMENTS

As used herein, the term “Stirling engine” refers to a plurality of cylinder modules that are interconnected kinematically and/or thermodynamically. As used herein, the term “Stirling engine machine” refers to a plurality of Stirling engines that are grouped together as described herein to cancel out or reduce dynamic forces created during operation of the Stirling engine. A “cylinder module” in one embodiment refers to a component of a Stirling engine, which can define an enclosed chamber 80 and can include a piston, a connecting rod, a linear generator, and a working fluid as described below. As is known in the art of Stirling engines, the piston divides the chamber 80 of the cylinder module into a variable hot volume on one side of the piston and a variable cold volume on the other side of the piston.

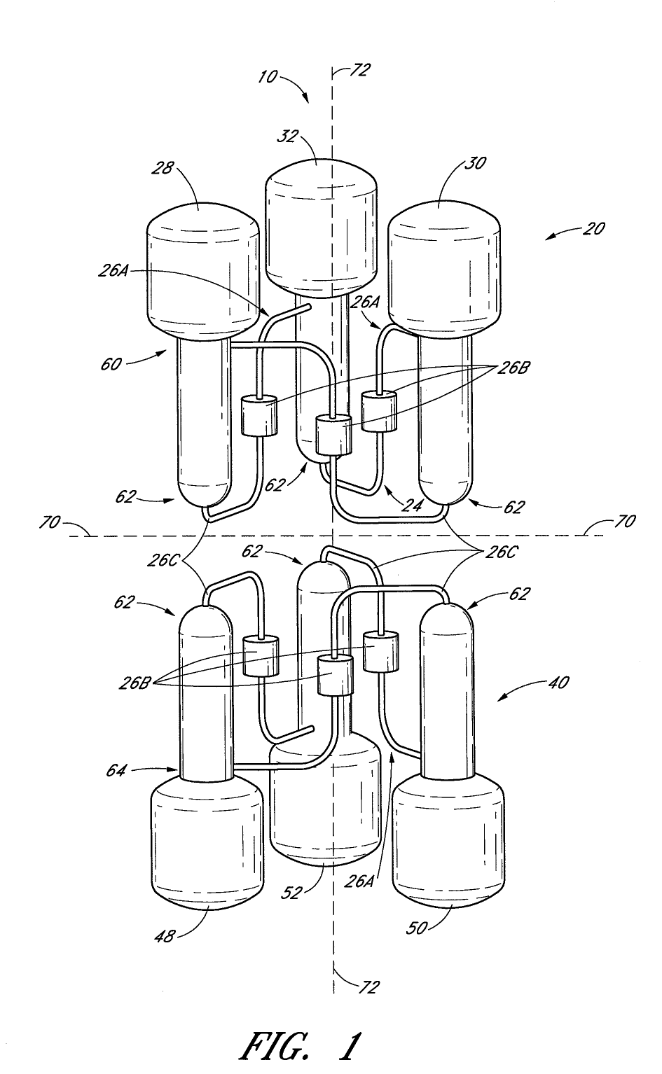

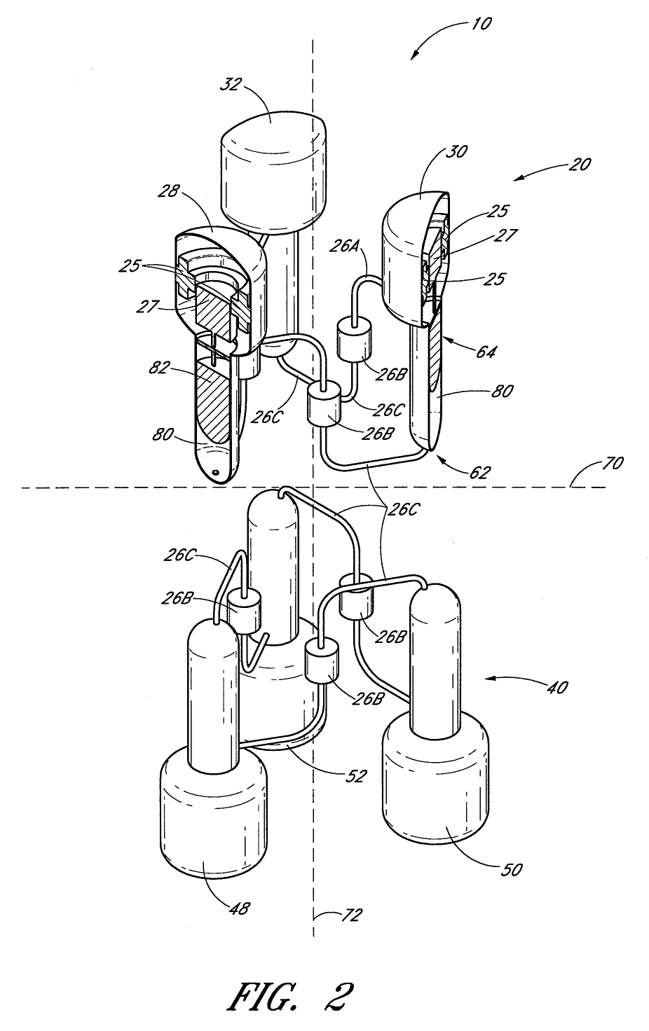

FIGS. 1-2 illustrate a first embodiment of a Stirling engine machine 10. In the illustrated embodiment, the machine 10 includes a first Stirling engine 20 and a second Stirling engine 40. However, other embodiments can comprise different numbers of Stirling engines as will be described below. With particular reference to FIG. 1, the first engine 20 is comprised of a first cylinder module 28, a second cylinder module 30, and a third cylinder module 32, which can be connected to share a working fluid. Similarly, the second engine 40 is comprised of a fourth cylinder module 48, a fifth cylinder module 50, and a sixth cylinder module 52, which can also be connected to share a working fluid. As best seen in FIG. 2, each cylinder module 21 can define an enclosed chamber 80 and can include a displacer piston 82, a power piston 27, and a working fluid (not shown). A linear alternator 25 can also be provided to generate power from movement of the power piston 27 and/or control movement of the power piston, as is know in the art.

In operation, the displacer piston 82 moves working fluid from an unheated or cooled side 60 of a chamber 80 of one cylinder module to a heated side 62 of the chamber 80 of a second module. This causes the working fluid to expand. The fluid expansion pushes the power piston 27.

As shown in the illustrated embodiment, the cylinder modules in each engine 20, 40 can be interconnected as shown by passages 24 that connect the hot side of one module with a cold side of another module. The passages can include a cooler 26A, a regenerator 26B, and a heater 26C. In the illustrated embodiment, the cooler 26A and heater 26C are illustrated schematically as a singular tube for ease of illustration. However, those of skill in the art will recognize that the cooler 26A and heater 26C will typically comprise additional components to promote heat transfer such as for example a plurality of tubes, fins, heat exchangers and the like. In a similar manner, the regenerator 26B will also typically comprise additional components configured to promote heat transfer such as for example a tubes, fins, heat exchangers and the like.

Thus, in the illustrated embodiment, each Stirling engine 20, 40 comprises three cylinder modules interconnected by three passages 24, each comprising a cooler 26A, a regenerator 26B and a heater 26C. By connecting the ends of the modules with passages 24, the pistons 27 can operate in different phases of the Stirling cycle and alternately act as the displacer piston and the power piston relative to other cylinder modules in the engine. Thus, in the illustrated embodiment, the pistons 82, 27 are not mechanically coupled to each other. Accordingly, the illustrated embodiment is a free piston Stirling cycle machine. The machine 10 can be provided with overstroke protection as described in U.S. Pat. No. 7,134,279, which has been incorporated by reference herein. In addition, although each engine 20, 40 is shown with three cylinder modules, in modified embodiments, four-, five-, six- or more modules can also be used with the modules fluidly, thermodynamically and/or mechanically coupled together.

As can be seen in FIGS. 1 and 2, the first and second engines 20, 40 can be arranged such that the modules 28, 30, 32, 48, 50, 52 are positioned substantially symmetrically about a first or longitudinal axis 72. Moreover, in the illustrated embodiment, the longitudinal axes of the individual cylinder modules are substantially parallel to each other and the longitudinal axis 72 of the engines 20, 40 and uniformly distributed in a first radial pattern in a first plane. Within each engine, the substantially sinusoidal motions of the pistons, 27, 82 can be controlled such that the center of mass (and preferably also velocity) remains in a single plane that is generally perpendicular to the longitudinal axis 72. In a modified embodiment, to account for modules of different weight and dynamic characteristics, the modules can be arranged asymmetrically about the longitudinal axis.

To further dynamically balance the machine, the first engine 20 and second engines 40 are preferably also arranged such that the cylinder modules 28, 30, 32 of the first engine 20 generally oppose the corresponding cylinder modules 48, 50 52 of the second engine 40. In general, cylinder modules generally oppose each other when (a) the longitudinal axes of the pistons 27, 82 are substantially aligned with each other and (b) the hot ends of corresponding cylinder modules are in proximity to one another, or the cold ends of corresponding cylinder modules are in proximity to one another. In the illustrated embodiment, the longitudinal axis of the pistons 27, 82 are also generally parallel to the longitudinal axis 72 of the machine 10.

As shown in FIGS. 1 and 2, within the first engine 20, the first cylinder module 28 can be connected through its cooled end 60 to the heated end 62 of the second cylinder module 30, which can be connected through its cooled end 60 to the heated end 62 of the third cylinder module 32, which is, in turn, connected through its cooled end 60 to the heated end of the first cylinder module 28. In the second engine 30, the fourth cylinder module 48 is connected through its cooled end 60 to the heated end 62 of the fifth cylinder module and the fifth cylinder module 50 is connected through its cooled end to the sixth cylinder module 52, which, in turn, is has its heated end connected to the cooled end of the fourth cylinder module 48.

In addition, in the illustrated embodiment, the heated ends 62 of all the cylinder modules 28, 30, 32, 48, 50, 52 are opposed to each other. Thus, the second engine 40 can viewed as being oriented approximately 180° about a horizontal axis 70 relative to the first engine 20 to create the opposing cylinder module pairs described above. The power cycle in both the first and second engines 20, 40 can proceed in the same counter-clockwise direction around the longitudinal axis 72 of both engines 20, 40. That is, the phasing between the first and second engines 20, 40 can be controlled such that the phase of opposing cylinder modules is the same. Accordingly, the piston positions in the first and fourth cylinder modules 28, 48 can be controlled to be in the same position during the power cycle. The second and fifth modules 30, 50 can be similarly operated, as can the third and sixth modules 32, 52. Accordingly, for example, the pistons in opposing cylinder modules can both reach top dead center (TDC) and bottom dead center (BDC) at substantially the same time. Because the cylinder modules are pointed in opposite directions (i.e., the hot ends are adjacent to each other), the inertial forces arising from the motions of the pistons will cancel each other outer (assuming substantially equal masses and motion).

Thus, when the engine machine 10 is arranged such that the longitudinal axes of the cylinder modules 28, 30, 32 of the first engine 20 are aligned with the longitudinal axes of the cylinder modules 48, 50, 52 of the second engine 40 in the pair-wise configuration described above, the inertial motions of the first and second engines 20, 40 relative to the horizontal axis 70 are substantially cancelled out when the mass of the pistons is equal and the amplitude of the expansion in each cylinder is equal or some combination of mass and amplitude produce cancelling results. Thus, the net outward force and torque experienced by the machine 10 relative to the center of the machine are cancelled or reduced to substantially zero. This advantageously can create dynamic stability within the engine and reduce the strain on the support structure on which the machine is mounted.

The above-described dynamic balancing can also be achieved with greater or fewer cylinder modules. In one non-limiting example, a four-module engine can be used to alternate inertial positions within each engine 20, 40, thereby further enhancing dynamic stability. Likewise, for any number of cylinder modules in a given engine, a similar engine can be disposed across the horizontal axis 70 to create dynamic stability. In some cases, engines with dissimilar numbers of cylinder modules can be balanced. In those cases, the mass and speed of the pistons must be calibrated to reach stable operation.

As mentioned above, in the illustrated embodiment of FIGS. 1-2, the heated ends 62 of all the cylinder modules 28, 30, 32, 48, 50, 52 can be opposed to each other and thus are advantageously disposed in a central location allowing for uniform and compact heating. Moreover, by arranging the cylinder modules 28, 30, 32, 48, 50, 52 symmetrically about the longitudinal axis 72, the heat source can be concentrated to one location, and not arranged along a linear path reaching all module ends, thereby decreasing the complexity of the Stirling engine machine, and increasing the efficiency by tightly confining the heating region. In a modified embodiment, the cold ends 60 of the engine can be generally opposed to each other. In yet another embodiment, the machine 10 is used as a refrigerator or cooler by using the linear generators as linear motors and pulling heat from the hot side and rejecting heat at the cold side of each cylinder module.

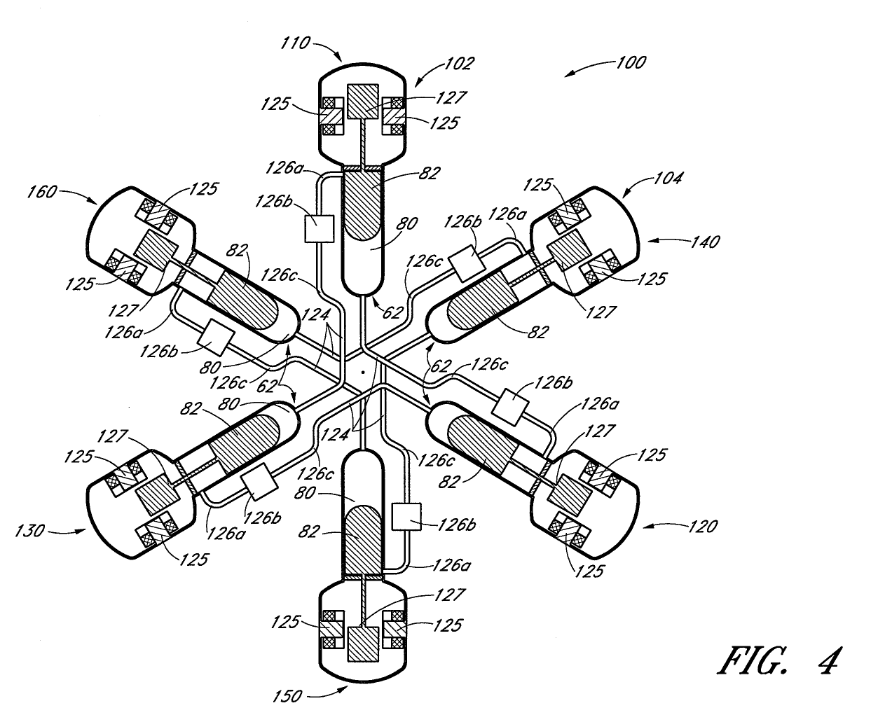

FIG. 4 illustrates another embodiment of a Stirling engine machine 100. As with the first embodiment, the Stirling engine machine 100 includes opposing cylinder modules arranged such that the movement of the pistons therein dynamically cancel each other so as to improve the dynamic balance of the engine 100.

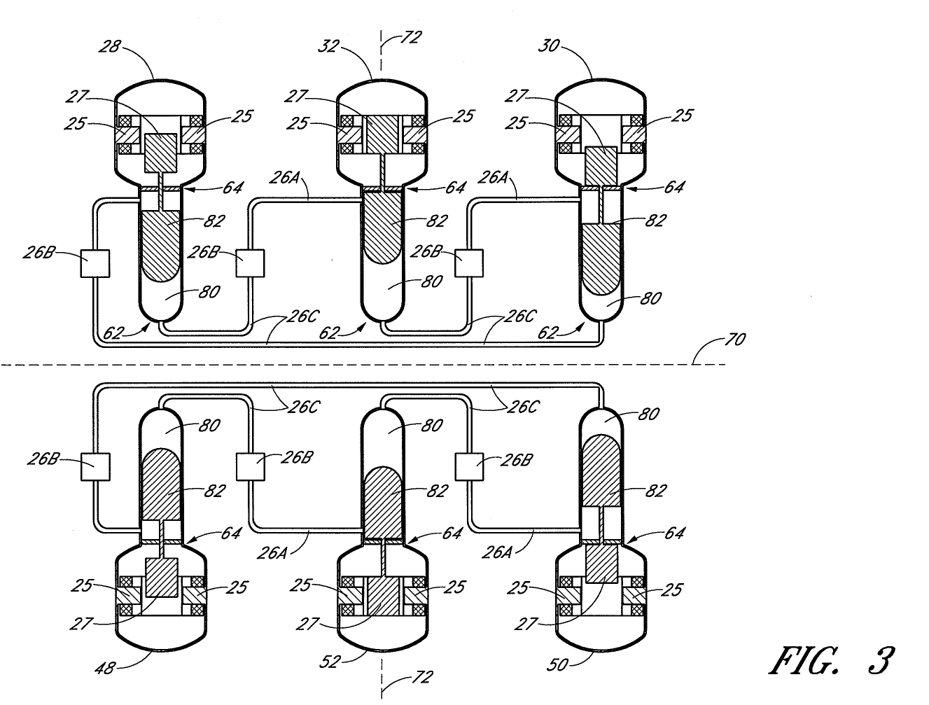

In the illustrated embodiment, the first engine 102 comprises first, second, and third cylinders modules 110, 120, 130. Similarly, the second engine 104 comprises fourth, fifth, and sixth cylinders modules 140, 150, and 160. Each cylinder can be connected to the other two modules in the engine 102, 104 through passages 124. Each passage 124 can include a cooler 126A, a regenerator 126B and a heater 126C as discussed above. In the embodiment illustrated in FIG. 4, the engines 102, 104 operate as described above for FIGS. 1-3, except that the geometry and arrangement of the cylinder modules 110, 120, 130, 140, 150, 160 has been changed as described below. Each cylinder module can also include a linear alternator 127 as described above for converting linear motion to electricity and/or moving a piston.

As can be seen in the illustrated embodiment, the engines 102, 104 can be disposed in a symmetrical arrangement about a central axis 101 that extends perpendicular to the page. The six cylinder modules 110, 120, 130, 140, 150, 160 can be arranged such that their longitudinal axis and the longitudinal axes of the pistons therein extend generally radially from the central axis of the machine 100. The modules of first and second engines 102, 104 are preferably arrayed around a circle in 120° intervals relative to other cylinder modules of the same engine 102, 104. The cylindrical modules of the two engines are then uniformly interleaved yielding 60 degree angles between a given cylinder module and the two adjacent cylinder modules of the other engine. Thus, the first cylinder module 110 is disposed between the sixth cylinder module 160 and the fourth cylinder module 140. The fifth cylinder module 150 is disposed directly across the arrangement from the first cylinder module 110. This is unlike the previous Stirling engine machine 10, wherein the first and fourth cylinder modules are shown disposed along the same longitudinal axis.

In the illustrated embodiment, the engines 102, 104 can be coordinated such that as the piston 82 of the first cylinder 110 expands radially outward from the center of the machine 100, the piston 82 of the fifth cylinder 150 also is expanding radially outward. Accordingly, the inertial and dynamic load on the machine 100 remains stable as the dynamic forces of the pistons 82 cancel each other out. Similarly, the third and fourth cylinders 130, 140 can be controlled to have inertial movement that cancel each other out, as can the second and sixth 120, 160 cylinders. In this way, the Stirling engine machine 100 can have pistons 82 in corresponding pairs that are dynamically stable with respect to the center of the machine 100 at all times.

Thus, in this embodiment, the machine 100 can be controlled such that the first and fifth cylinder modules 110, 150 are in the same position during the power cycle, i.e., possess the same phase of the power cycle. The third and fourth cylinders 130 can be similarly operated, as can the second and sixth 120, 160. Accordingly, for example, the pistons in opposing cylinder modules can both reach top dead center (TDC) and bottom dead center (BDC) at substantially the same time. Because the cylinder modules are pointed in opposite directions (i.e., the hot ends are adjacent to each other), the inertial forces arising from the motions of the pistons cancel each other outer (assuming substantially equal masses and motion).

Additionally, in one aspect of the illustrated embodiment, each of the heated ends 62 of the cylinder modules 110, 120, 130, 140, 150, 160 are disposed at a central position. Accordingly, all of the ends can be heated from one or several closely adjacent heat sources, reducing the distance between heat sources or allowing the heat sources to be simplified to a single heat source, i.e., a common heat source shared by a plurality of cylinder modules. In a modified embodiment, the cooled ends 60 of the modules can be arranged at the center of the machine 100.

In some embodiments, the heating method can be gas convection, solar radiation (concentrated or unfocused), liquid convection, conduction from a heat source, internal combustion, or any other useful method of providing heat to the machine 10. In some embodiments, the cooled ends 60 can be actively cooled, increasing the temperature range of operation of the working fluid. Any useful and appropriate cooling method, including liquid or gas convection or conduction can be used to cool the cylinder modules. In addition, as mentioned above, the engines described herein can be reversed such that they are configured to provide refrigeration by removing heat from the heated end 62 and transferring heat to the cooled end 60.

Moreover, in another aspect of the illustrated embodiment, the circular geometry can reduce the space necessary for containing the Stirling engine machine 100 to a single circular section, allowing for compact placement of multiple machines. It should also be appreciated that the embodiment of FIG. 4 is not limited to a machine 100 comprising two engines consisting of three cylinder modules. That is, the principle of canceling out dynamic forces of opposing cylinders can also be applied to a machine comprising more than one engine and engines comprising three or more cylinder modules.

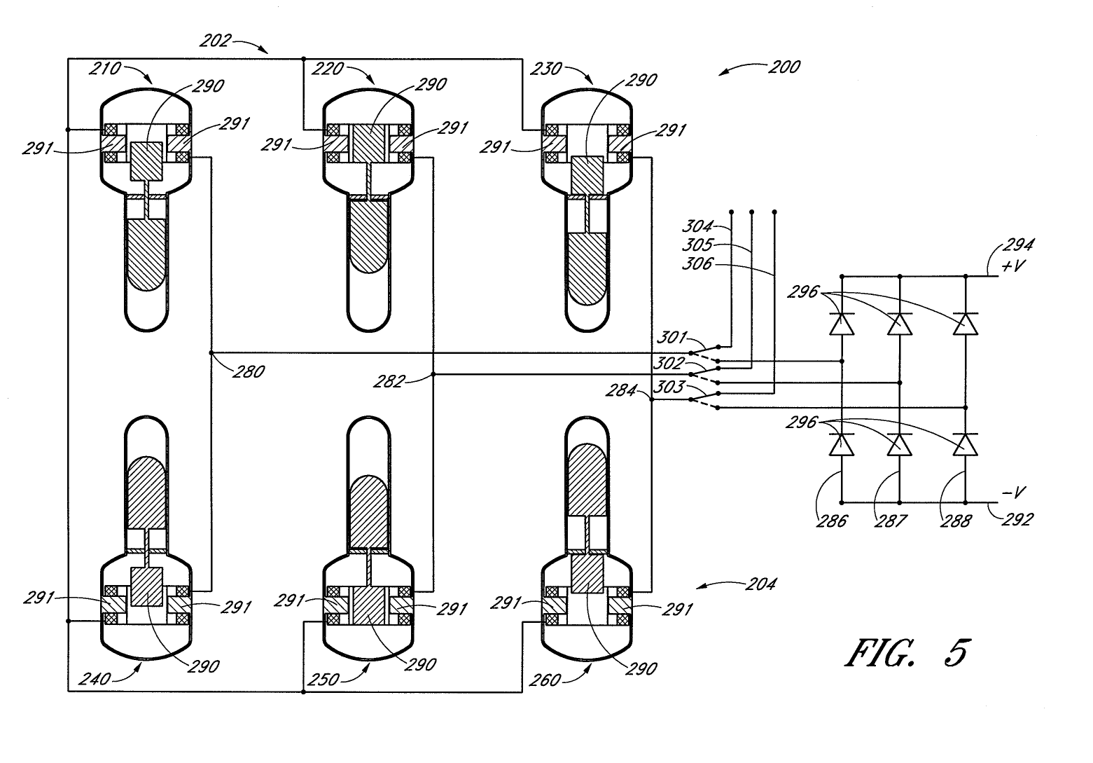

FIG. 5 is a schematic illustration showing electrical connections within an embodiment of a Stirling engine machine 200 that comprises a pair of engine each comprising three cylinder modules. As can be seen in the illustrated embodiment, the first engine 202 and second engine 204 can be electrically connected such that power produced by the machine 200 is provided as rectified direct current (DC) power, even though the power produced by individual cylinder modules 210, 220, 230, 240, 250, 260 are out of phase from each other because of the progressing cycle of the Stirling engines 202, 204.

In the illustrate embodiment, the paired cylinders including a first pair with first and fourth cylinder modules 210, 240, a second pair with second and fifth cylinder modules 220, 250, and a third pair with third and sixth cylinder modules 230, 260—are electrically connected. Additionally, consistent with the embodiment described in reference to FIGS. 1-3, the cylinder modules can be controlled to participate in the Stirling cycle in the same phases for paired cylinder modules. Accordingly, electrical power produced by the linear alternators in each of the paired cylinders is in phase. To rectify the phase of electrical power produced, a series of electrical circuits 286, 287, 288 operating in parallel, each circuit having two diodes can be constructed. The power at the terminals 292, 294 can then be rectified DC current.

In one embodiment, to start the engine, the heaters 26C, 126C are brought to an operating temperature. The linear generated are then activated such that act as linear motor, causing the pistons to oscillate in the cylinder modules with the proper phase relationship to each other. Once started, the relays 300 may be thrown to a run position (shown in dashed lines in FIG. 5), which removes the engine from the starting circuit and connects it to the illustrated rectifying diode bridge if DC output is desired or in a modified embodiment connects it directly to a 3 phase load. In another embodiment, an engine with low enough internal friction can start spontaneously from any small random disturbing force once a temperature difference has been established across the heaters 26C, 126C, as is the case with a conventional free piston engine. With reference to FIG. 5, pairs of opposed cylinder modules are preferably wired in parallel so that they are forced to stay in phase with each other. The tendency of pistons within each engine to equalize phase differences between them is a natural phenomenon of the system. See e.g., U.S. Pat. No. 7,134,279.

Although this invention has been disclosed in the context of certain preferred embodiments and examples, it will be understood by those skilled in the art that the present invention extends beyond the specifically disclosed embodiments to other alternative embodiments and/or uses of the invention and obvious modifications and equivalents thereof. In addition, while the number of variations of the invention have been shown and described in detail, other modifications, which are within the scope of this invention, will be readily apparent to those of skill in the art based upon this disclosure. It is also contemplated that various combinations or subcombinations of the specific features and aspects of the embodiments may be made and still fall within the scope of the invention. Accordingly, it should be understood that various features and aspects of the disclosed embodiments can be combined with, or substituted for, one another in order to perform varying modes of the disclosed invention. Thus, it is intended that the scope of the present invention herein disclosed should not be limited by the particular disclosed embodiments described above, but should be determined only by a fair reading of the claims.

What is claimed is:

1. A Stirling engine machine comprising:
a first group of cylinder modules, each member of the first group of cylinder modules comprising a piston that moves along a longitudinal axis; and
a second group of cylinder modules, each of member of the second group of cylinder modules comprising a piston that moves along a longitudinal axis;
wherein the longitudinal axis of each member of the first group of cylinder modules is substantially aligned with the longitudinal axis of a corresponding member of the second group of cylinder modules.

2. The Stirling engine machine of claim 1, further comprising a controller configured to operate the Stirling cycle machine such that the pistons of corresponding cylinder modules move in substantially opposite directions during operation of the machine.

3. The Stirling engine machine of claim 1, wherein each of the first and second group of cylinders are distributed about a first axis.

4. The Stirling engine machine of claim 3, wherein the longitudinal axes of the first and second groups extend generally radially from the first axis.

5. The Stirling engine machine as in claim 4, wherein the cylinder modules of the first and second groups each have hot and cold ends and the hot ends of the corresponding cylinder modules are in proximity to each other.

6. A Stirling engine machine of claim 3, wherein the longitudinal axes of the first and second groups of cylinder modules extend generally parallel to the first axis and the first group of cylinder modules is on a first side of a plane that is generally perpendicular to the longitudinal axes of the first and second groups of cylinder modules and the second group of cylinder modules is on a second side of the plane.

7. A Stirling engine machine of claim 6, wherein the cylinder modules of the first and second groups each have hot and cold ends and the hot ends of the corresponding cylinder modules are generally adjacent to each other.

8. A Stirling engine machine claim 1, wherein each of the first group of cylinder modules is fluidly connected by a connection to at least one other member of the first group of cylinder modules.

9. A Stirling engine machine of claim 8, wherein each connection comprises a heater, a cooler and a regenerator.

10. A Stirling engine machine of claim 1, wherein a heat source is disposed between corresponding of cylinder modules.

11. A Stirling engine machine comprising a first group of at least three cylinder modules and a second group of at least three cylinder modules, each cylinder module comprising at least one piston that moves along a longitudinal axis, the longitudinal axes of the cylinder modules being substantially uniformly distributed in a radial pattern in a common plane.

12. The Stirling engine machine as in claim 11, wherein each cylinder module of the first group is opposed by cylinder module of the second group.

13. The Stirling engine machine of claim 12, wherein each of the cylinder modules include a hot end and the hot ends of opposing cylinder modules are positioned in proximity to a center of the radial pattern.

14. The Stirling engine machine of claim 12, wherein each of the cylinder modules include a cold end and cold ends of opposing cylinder modules are positioned in proximity a center of the radial pattern.

15. The Stirling engine machine of claim 12, wherein the first group and second group of cylinder modules are operate such that the pistons of opposing cylinder modules are dynamically balanced with each other.

16. The Stirling engine machine of claim 11, wherein the fluid modules of the first group are fluidly connected to each other and the fluid modules of the second group are fluidly connected to each other.

17. The Stirling engine machine of claim 11, wherein the Stirling cycle machine is configured to provide cooling.

18. A Stirling engine machine comprising:
a first group of cylinder modules, each cylinder module of the first group characterized by a longitudinal axis, the longitudinal axes of the cylinder modules being substantially parallel to each other and uniformly distributed in a first radial pattern in a first plane; and
a second group of cylinder modules, each cylinder module of the second group characterized by a longitudinal axis, the longitudinal axes of the cylinder modules being substantially parallel to each other and uniformly distributed in a second radial pattern in a second plane.

19. A Stirling machine comprising a plurality of pairs of cylinder modules, each cylinder module comprising a first end, a second end, and at least one piston moveable along a longitudinal axis extending between the first and second ends, wherein the two cylinder modules of each of the pairs of cylinder modules have axes that are substantially aligned with each other in opposite directions such that movement of the pistons of each of the plurality of pairs substantially dynamically cancel.

20. The Stirling machine of claim 19, wherein the first ends comprise a hot side of the cylinder module, and the first ends of each of the plurality of pairs of cylinder modules are in proximity to each other.

21. The Stirling machine of claim 19, wherein pairs of opposing cylinder modules comprise portions of different Stirling cycle engines.
